(19) United States
(12) Patent Application Publication
(10) Pub. No.: US 2016/0200591 A1
(43) Pub. Date: Jul. 14, 2016

(54) MICROEMULSION-ENABLED WATER CAPTURE AND RECOVERY

(71) Applicant: UNIVERSITY OF MARYLAND, College Park, MD (US)

(72) Inventors: Bao YANG, Ellicott City, MD (US); Reinhard RADERMACHER, Silver Spring, MD (US); Fangyu CAO, College Park, MD (US); Baolan (Jessica) SHI, Palo Alto, CA (US)

(73) Assignee: University of Maryland, College Park, MD (US)

(21) Appl. No.: 14/912,385

(22) PCT Filed: Aug. 19, 2014
(86) PCT No.: PCT/US2014/051700

§ 371 Date: Feb. 16, 2016

Related U.S. Application Data
(60) Provisional application No. 61/867,509, filed on Aug. 19, 2013.
(60) Provisional application No. 61/987,280, filed on May 1, 2014.

(51) Int. Cl. C02F 1/02

(52) U.S. Cl. CPC C02F 1/02; C02F 2103/34

(57) ABSTRACT

A heat transfer apparatus (104) comprising: (i) an adsorption/absorption chamber (122) in fluid communication with an exhaust stream (118) from a wet-cooling tower (112) and in heat transfer communication with a cooling source (120), the adsorption/absorption chamber (122) containing a microemulsion (124) which adsorbs/absorbs water vapor present in the exhaust stream (118), when cooled, as water droplets sequestered within the microemulsion (124) to form a used microemulsion (126); and (ii) a desorption chamber (134) in fluid communication with the adsorption/absorption chamber (122) and the wet-cooling tower (112), and in heat transfer communication with a heat source capable of desorbing the water droplets out of the used microemulsion (126) as liquid water (140), without vaporizing the water, to form a regenerated microemulsion (138). Also, methods of using the heat transfer apparatus.

Provided are apparatus and methods for microemulsion-enabled water capture and recovery, capable, for example, of condensing water vapor existing in an exhaust stream exiting a wet-cooling tower, such as a wet-cooling tower of a power plant.

About 99 percent of thermal-electric power plants use water in their cooling systems. These thermal-electric power plants account for about 40 percent of total freshwater withdrawals and about 3 percent of total freshwater consumption in the United States. The cooling systems of these power plants account for about 90 percent of power plant water usage in the United States. To date, no practical methods of extracting water from the cooling tower of wet-cooling thermal-electric power plants have been developed.

The remaining about 1 percent of thermal-electric power plants utilize air cooled condensing (“ACC”) cooling systems, in many instances because the power plant is not near a water source. In some instances, the thermal-electric power plants which use ACCs are located in regions which experience relatively high average temperatures, such as deserts. During times of high outdoor temperatures, the ACCs are less efficient due to the higher ambient air temperature, which can result in a power production penalty of up to about 10%. Also, nuclear power plants may not be able utilize ACCs due to regulation and safety concerns. Furthermore, the footprint of an ACC may be much larger than the footprint of a water-cooled cooling system, due to the less efficient heat transfer accomplished by air as compared to water.

What is needed are apparatus and/or methods which reduce thermal-electric power plant water consumption and reduce cooling system size, and which may be utilized in various types of thermal-electric power plants. Further, it may be desirable to replace ACC systems with a conventional wet-cooling system associated with a means for capturing most or all of the water used in the wet-cooling system, in order to reduce cooling system size.

Embodiments of the subject matter are disclosed with reference to the accompanying drawings and are for illustrative purposes only. The subject matter is not limited in its application to the details of construction or the arrangement of the components illustrated in the drawings. Like reference numerals are used to indicate like components, unless otherwise indicated.

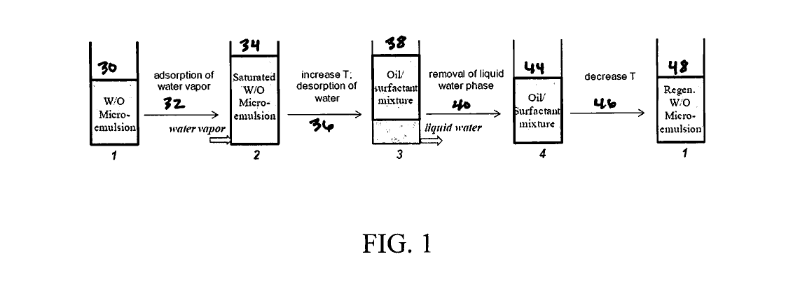

FIG. 1 is a schematic diagram of an illustrative adsorption/absorption and desorption process utilizing the subject microemulsion.

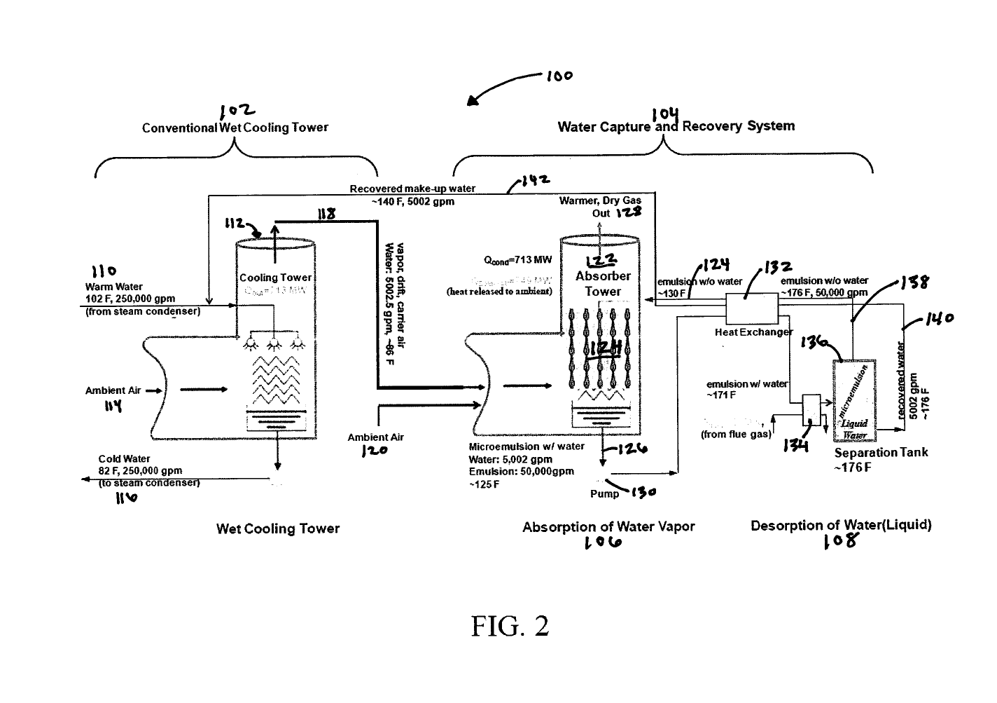

FIG. 2 is a schematic diagram of an illustrative adsorption/absorption and desorption process utilized in connection with a conventional wet-cooling tower.

Provided is an apparatus comprising: (i) an adsorption/absorption chamber in fluid communication with an exhaust stream from a wet-cooling tower and in heat transfer communication with a cooling source, the adsorption/absorption chamber containing a microemulsion which adsorbs/absorbs water vapor present in the exhaust stream, when cooled, as water droplets sequestered within the microemulsion to form a used microemulsion; and (ii) a desorption chamber in fluid communication with the adsorption/absorption chamber and the wet-cooling tower, and in heat transfer communication with a heat source capable of desorbing the water droplets out of the used microemulsion as liquid water, without vaporizing the water, to form a regenerated microemulsion.

In certain embodiments, the wet-cooling tower may be a wet cooling tower of a power plant.

In certain embodiments, the desorption chamber comprises a separating device capable of: (a) separating the liquid water from the regenerated microemulsion; (b) routing the liquid water to the wet-cooling tower; and (c) routing the regenerated microemulsion to the adsorption/absorption chamber.

Attempts have been made to utilize sorption refrigeration systems for power plant cooling using “conventional sorption agents”. Sorption refrigeration systems are desirable because they may be driven by low-grade heat, not requiring electricity or other sources of energy or power. Conventional sorption agents are classified into two general categories: adsorbents and absorbents. Examples of absorbent/refrigerant pairs include lithium bromide/water and water/ammonia. During absorption, the refrigerant molecules are entirely dissolved or diffused in the absorbent for form a solution. Examples of adsorbent/refrigerant pairs include zeolite/water and silica/water. Adsorption is a surface-based process where a layer of refrigerant is adsorbed on the surface of the adsorbent. Both absorption and adsorption are exothermic, while desorption is endothermic. Heat is required to desorb the refrigerant out of the absorbent or off of the adsorbent.

Examples of conventional sorption agents include lithium bromide, lithium chloride, calcium chloride, zeolite and silica. A key deficiency of conventional sorption agents, however, is that they release the refrigerant (such as water) as a gas. Because the refrigerant must be released as a gas, the only way to effect desorption of the refrigerant is to impart sufficient energy to the conventional sorption agent to cause the refrigerant to undergo a phase change. Using water as an exemplary refrigerant, this would require that the heat of vaporization of water (2,360 J/g at 60° C.) be imparted to the conventional sorption agent. Furthermore, because the refrigerant is desorbed as a gas, it must be condensed before continuing the refrigeration cycle.

In contrast, the microemulsions used in the present subject matter are able to release the refrigerant as a liquid, which drastically reduces the energy required to effect desorption of the refrigerant, and also eliminates the requirement of condensing the refrigerant before continuing the refrigeration cycle. Table 1 shows the required heat of desorption (Q_{d}) for various exemplary sorption agents (sorbents), using water as an exemplary refrigerant.

TABLE 1

| Sorbent | Microemulsion | LiBr | LiCl | CaCl₂ | Zeolite |
|---|---|---|---|---|---|
| Q_{d} | ~100 J/g | ~2,500 J/g | ~2,500 J/g | ~2,500 J/g | ~3,400 J/g |

The microemulsion used in the present subject matter comprise inverse micelles of surfactant (such as amphiphilic surfactant) in oil (such as apolar oil). When the surfactant concentration in the oil/surfactant mixture exceeds the critical micelle concentration (“CMC”), the surfactant molecules form inverse micelles via spontaneous self-assembly in the oil.

The CMC may be defined as the concentration of surfactants above which micelles or inverse micelles form. The CMC can be determined by measuring the surface tension of the oil/surfactant mixture. Before reaching the CMC, the surface tension changes strongly in relation to the concentration of surfactant in the mixture. After reaching the CMC, the surface tension remains relatively constant or changes little in relation to the concentration of surfactant in the mixture. Small angle neutron scattering (“SANS”) may also be used to measure the fluid internal structure to determine whether the CMC has been reached. The value of the CMC depends on temperature, pressure, and the presence and concentration of other surface active substances. For example, the value of CMC for sodium dodecyl sulfate in water at 25° C. and atmospheric pressure is 0.008 mol/L, without other additives or salts.

The hydrophobic tail of each surfactant molecule is in contact with the surrounding oil, sequestering the hydrophilic head of the surfactant at the center of the micelle. The hydrophilic head groups of each surfactant molecule have strong physiochemical affinity for refrigerant (such as water) molecules, and can therefore adsorb refrigerant vapor into the inner surface of the inverse micelle, forming refrigerant nanodroplets sequestered in each micelle. Because the refrigerant is adsorbed by the micelles within the microemulsion, it can also be said that the refrigerant is absorbed into the microemulsion, resulting in both adsorption and absorption.

At low temperatures (such as room temperature), the hydrophilic head groups of the surfactant molecules provide effective adsorption sites for refrigerant. As temperature increases, the inverse micelles dissociate while releasing the refrigerant nanodroplets. So long as the temperature required to release the refrigerant nanodroplets is lower than the boiling point of the refrigerant, the refrigerant will be released as a liquid. The refrigerant nanodroplets will coalesce and separate from the oil/surfactant solution. For example, when water is the refrigerant, the water droplets will coalesce and fall out of the oil/surfactant solution.

Referring to FIG. 1, the adsorption/absorption and desorption process may be described as follows. A microemulsion 30 adsorbs 32 water vapor to form an at least partially saturated microemulsion 34. The temperature of the saturated microemulsion 34 is increased 36 to separate liquid water 42 from a first oil/surfactant mixture 38. The liquid water 42 is removed 40 to provide a second oil/surfactant mixture 44. The temperature of the second oil/surfactant mixture 44 is decreased 46 to spontaneously regenerate the surfactant micelles to provide a regenerated microemulsion 48, which can be recycled for reuse in the cyclical refrigeration process.

In certain embodiments, the microemulsion may comprise at least one oil and at least one surfactant, the at least one surfactant molecules comprising a hydrophobic end and a hydrophilic end.

In certain embodiments, the at least one oil has a boiling point greater than about 100° C. at 100 kPa. The at least one oil may have a carbon-hydrogen atomic fraction of greater than about 70%.

In certain embodiments, the at least one oil may comprise at least one polyalphaolefin.

In certain embodiments, the at least one surfactant may comprise at least one of organosulfate salts, sulfonate salts or anhydride amino esters. The at least one surfactant may comprise at least one of sodium dodecyl sulfate or dioctyl sodium sulfosuccinate.

In certain embodiments, the adsorption/absorption chamber may comprise an adsorption/absorption tower in fluid communication with the wet-cooling tower to receive the exhaust stream, wherein the cooling source comprises a source of ambient air adapted to transport the ambient air through the adsorption/absorption tower cocurrently with the exhaust stream, and wherein the adsorption/absorption tower is adapted to transport the microemulsion through the adsorption/absorption tower countercurrently to the exhaust stream and the ambient air.

In certain embodiments, the apparatus may comprise a desorption chamber which comprises a heat exchanger having a first side and a second side, wherein the first side comprises an inlet and an outlet, wherein the first side inlet is in fluid communication with the adsorption/absorption chamber to receive the used microemulsion, wherein the first side outlet is in fluid communication with the separating device to exhaust the regenerated microemulsion and the liquid to the separating device, wherein the second side is in direct or indirect heat transfer communication with a waste heat source supplied from a steam generator of the power plant.

In certain embodiments, the apparatus may further comprise a heat exchanger having a first zone and at least one of a second zone or a third zone, wherein the first zone comprises an inlet and an outlet, wherein the second zone comprises an inlet and an outlet, wherein the third zone comprises an inlet and an outlet, wherein the first zone inlet is in fluid communication with the adsorption/absorption chamber to receive the used microemulsion, wherein the first zone outlet is in fluid communication with the desorption chamber to exhaust the used microemulsion to the desorption chamber, wherein the second zone inlet is in fluid communication with the separation device to receive the regenerated microemulsion, wherein the second zone outlet is in fluid communication with the adsorption/absorption chamber to return the regenerated microemulsion to the adsorption/absorption chamber, wherein the third zone inlet is in fluid communication with the separation device to receive the liquid water, wherein the third zone outlet is in fluid communication with the wet-cooling tower to return the liquid water to the wet-cooling tower, wherein at least one of the regenerated microemulsion or the liquid water is cooled via the heat exchanger, and wherein the used microemulsion is heated via the heat exchanger.

Also provided is a method of condensing water vapor and/or capturing water droplets in an exhaust stream exiting a wet-cooling tower comprising: (i) transporting the exhaust stream into an adsorption/absorption chamber containing a microemulsion; (ii) providing the adsorption/absorption chamber with a cooling source to cause the microemulsion to adsorb/absorb the water vapor as water droplets sequestered within the microemulsion, forming a used microemulsion; (iii) transporting the used microemulsion into a desorption chamber; (iv) providing the desorption chamber with a heat source to cause the water droplets in the used microemulsion to be released from the used microemulsion as liquid water, forming a regenerated microemulsion; (v) separating the liquid water from the regenerated microemulsion; (vi) routing the liquid water to the wet-cooling tower; and (vii) routing the regenerated microemulsion to the adsorption/absorption chamber. In certain embodiments, the method further comprises cooling at least one of the regenerated microemulsion or the liquid water by placing at least one of the regenerated microemulsion or the liquid water into heat transfer contact with the used microemulsion. In certain embodiments, the cooling source is supplied from an ambient environment. In certain embodiments, the heat supplied to the desorption chamber is directly or indirectly supplied from a waste heat source supplied from a steam generator of the power plant. In certain embodiments, the wet-cooling tower is a wet-cooling tower of a power plant.

The apparatus and methods described herein may significantly reduce or eliminate water consumption in wet-cooling towers of thermal-electric power plants, and, in connection with a wet-cooling tower, may be used to replace ACC systems in dry-cooling thermal-electric power plants. Thus, the apparatus and methods described herein may be considered to be dry-cooling systems, in that they may have minimal or no water loss. Furthermore, the cost of implementing the apparatus and methods described herein is about twice the cost of a conventional wet-cooling tower, but significantly less than the cost of an ACC system, which typically cost at least three to five times the cost of a conventional wet-cooling tower.

FIG. 2 illustrates an embodiment of the subject apparatus and/or methods associated with a wet-cooling tower of a 500-MWe, coal-fired steam power plant. A conventional wet-cooling tower 102 is retrofitted with a water capture and recovery system 104, which utilizes the subject microemulsion. The water capture and recovery system 104 includes an adsorption/absorption zone 106 and a desorption zone 108. It is noted that FIG. 2 illustrates only a single embodiment of the present subject matter, and that other arrangements of the present apparatus and/or methods may be possible according to the design parameters disclosed herein, such as utilizing the apparatus/methods with various types of thermal-electric power plants.

Warm water 110 exiting (directly or indirectly) a steam condenser (not shown) of the power plant at a rate of 250,000 gallons per minute (950,000 liters per minute) and a temperature of 102° F. (38.9° C.) is sprayed into a cooling tower 112, where it is cooled by first ambient air 114 flowing through the cooling tower 112. Cool water 116 exits the cooling tower at a rate of 250,000 gallons per minute (950,000 liters per minute) and a temperature of 82° F. (28° C.) proceeds (directly or indirectly) back to the steam condenser of the power plant. The heat output of the cooling tower 112 is 713 MW.

Cooling tower exhaust stream 118 exits the cooling tower 112, and includes water vapor, entrained water droplets (“drift”) and carrier air. The total water (vapor and drift) content of the exhaust stream 118 is 5,002.5 gallons per minute (18,937 liters per minute), and the temperature of the exhaust stream 118 is 86° F. (30° C.). The exhaust stream 118 and second ambient air 120 proceed to an adsorber/absorber tower 122, into which a stream of microemulsion 124 is injected at a rate of 50,000 gallons per minute (190,000 liters per minute) and a temperature of 130° F. (54.4° C.).

The injection may be accomplished in various ways, including merely spraying the microemulsion into the adsorber/absorber tower 122. In certain embodiments, a heat and mass exchanger may be used to place the stream of microemulsion 124 into contact with the exhaust stream 118 in order to optimize contact between the two streams and maximize water vapor/drift adsorption/absorption by the microemulsion 124.

The microemulsion 124 adsorbs/absorbs the water vapor and drift present in the exhaust stream 118, and exits the adsorber/absorber tower 122 as a used microemulsion 126. The used microemulsion includes 5,002 gallons per minute (18,930 liters per minute) of water and 50,000 gallons per minute (190,000 liters per minute) of microemulsion at a temperature of 125° F. (51.7° C.). Warm, dry gas 128 exits the adsorber/absorber tower 122 and is exhausted to the ambient environment. The heat released to the ambient environment includes 713 MW of heat output from the cooling tower 112 as well as an additional 36 MW of heat required to be removed from the microemulsion to adsorb/absorb the water vapor and drift, for a total heat output of 749 MW.

The used microemulsion 126 is transported by a pump 130 to a first heat exchanger 132, where it is pre-heated to about 171° F. (about 77.2° C.) before proceeding to a second heat exchanger 134 to about 176° F. (about 80° C.) to effect separation of liquid water from the used microemulsion in a separation tank 136 in order to create a regenerated microemulsion 138. The second heat exchanger 134 is in heat transfer communication with the flue gas stream from the power plant (not shown), which provides 33 MW of heat to increase the temperature of the used microemulsion 126.

The regenerated microemulsion 138 exits the separation tank 136 at about 176° F. (about 80° C.), and proceeds to the first heat exchanger 132 at a rate of 50,000 gallons per minute (190,000 liters per minute). The recovered water 140 exits the separation tank 136 at about 176° F. (about 80° C.), and proceeds to the first heat exchanger 132 at a rate of 5,002 gallons per minute (18,930 liters per minute). The regenerated microemulsion 138 and recovered water 140 are in heat transfer communication with the used microemulsion 126 within the first heat exchanger 132, in order to heat the used microemulsion 126 and cool the regenerated microemulsion 138 and recovered water 140.

The microemulsion 124 exits the first heat exchanger and returns to the adsorber/absorber tower 122 as described above. The cooled, recovered water 142 is returned to the cooling tower 112 at a temperature of about 140° F. (about 60° C.) and a rate of 5,002 gallons per minute (18,930 liters per minute).

As discussed above, only about 33 MW of “waste heat” from the flue gas of the power plant is needed to regenerate the used microemulsion. In contrast, if a conventional calcium chloride sorbent agent was used for the same purpose, about 800 MW of heat would be needed to regenerate the microemulsion. Because the flue gas from a 500 MWe coal-fired power plant is only able to provide about 70 MW, it is clear that it would not be possible to use conventional sorbent agents in the manner in which the subject microemulsions are used, as described above.

In a first embodiment of the present subject matter, provided is an apparatus comprising: (i) an adsorption/absorption chamber in fluid communication with an exhaust stream from a wet-cooling tower and in heat transfer communication with a cooling source, the adsorption/absorption chamber containing a microemulsion which adsorbs/absorbs water vapor present in the exhaust stream, when cooled, as water droplets sequestered within the microemulsion to form a used microemulsion; and (ii) a desorption chamber in fluid communication with the adsorption/absorption chamber and the wet-cooling tower, and in heat transfer communication with a heat source capable of desorbing the water droplets out of the used microemulsion as liquid water, without vaporizing the water, to form a regenerated microemulsion.

The apparatus of the first embodiment may further include that the wet-cooling tower is a wet-cooling tower of a power plant.

Either or both of the first or subsequent embodiments may further include that the desorption chamber comprises a separating device capable of: (a) separating the liquid water from the regenerated microemulsion; (b) routing the liquid water to the wet-cooling tower; and (c) routing the regenerated microemulsion to the adsorption/absorption chamber.

A second embodiment of the present subject matter comprises any of the first or subsequent embodiments, further including that the microemulsion comprises at least one oil and at least one surfactant, the at least one surfactant molecules comprising a hydrophobic end and a hydrophilic end.

The second embodiment may further include that the at least one oil has a boiling point greater than about 100° C. at 100 kPa, optionally wherein the at least one oil has a carbon-hydrogen atomic fraction of greater than about 70%.

Either or both of the second or subsequent embodiments may further include that the at least one oil comprises at least one polyalphaolefin.

Any of the second or subsequent embodiments may further include that the at least one surfactant comprises at least one of organosulfate salts, sulfonate salts or anhydride amino esters. The at least one surfactant may comprise at least one of sodium dodecyl sulfate or dioctyl sodium sulfosuccinate.

The apparatus of the first, second or subsequent embodiments may further include that the adsorption/absorption chamber comprises an adsorption/absorption tower in fluid communication with the wet-cooling tower to receive the exhaust stream, wherein the cooling source comprises a source of ambient air adapted to transport the ambient air through the adsorption/absorption tower cocurrently with the exhaust stream, and wherein the adsorption/absorption tower is adapted to transport the microemulsion through the adsorption/absorption tower countercurrently to the exhaust stream and the ambient air.

The apparatus of the first, second or subsequent embodiments may further include that the desorption chamber comprises a heat exchanger having a first side and a second side, wherein the first side comprises an inlet and an outlet, wherein the first side inlet is in fluid communication with the adsorption/absorption chamber to receive the used microemulsion, wherein the first side outlet is in fluid communication with the separating device to exhaust the regenerated microemulsion and the liquid to the separating device, and wherein the second side is in direct or indirect heat transfer communication with a waste heat source supplied from a steam generator of the power plant.

The apparatus of the first, second or subsequent embodiments may further comprise a heat exchanger having a first zone and at least one of a second zone or a third zone, (i) wherein the first zone comprises an inlet and an outlet, wherein the second zone comprises an inlet and an outlet, wherein the third zone comprises an inlet and an outlet, wherein the first zone inlet is in fluid communication with the adsorption/absorption chamber to receive the used microemulsion, wherein the first zone outlet is in fluid communication with the desorption chamber to exhaust the used microemulsion to the desorption chamber, wherein the second zone inlet is in fluid communication with the separation device to receive the regenerated microemulsion, wherein the second zone outlet is in fluid communication with the adsorption/absorption chamber to return the regenerated microemulsion to the adsorption/absorption chamber, wherein the third zone inlet is in fluid communication with the separation device to receive the liquid water, wherein the third zone outlet is in fluid communication with the wet-cooling tower to return the liquid water to the wet-cooling tower, wherein at least one of the regenerated microemulsion or the liquid water is cooled via the heat exchanger, and wherein the used microemulsion is heated via the heat exchanger.

In a third embodiment of the present subject matter, provided is a method of condensing water vapor and/or capturing water droplets in an exhaust stream exiting a wet-cooling tower comprising: (i) transporting the exhaust stream into an adsorption/absorption chamber containing a microemulsion; (ii) providing the adsorption/absorption chamber with a cooling source to cause the microemulsion to adsorb/absorb the water vapor as water droplets sequestered within the microemulsion, forming a used microemulsion; (iii) transporting the used microemulsion into a desorption chamber; (iv) providing the desorption chamber with a heat source to cause the water droplets in the used microemulsion to be released from the used microemulsion as liquid water, forming a regenerated microemulsion; (v) separating the liquid water from the regenerated microemulsion; (vi) routing the liquid water to the wet-cooling tower; (vii) routing the regenerated microemulsion to the adsorption/absorption chamber; and (viii) optionally cooling at least one of the regenerated microemulsion or the liquid water by placing at least one of the regenerated microemulsion or the liquid water into heat transfer contact with the used microemulsion. The wet cooling tower may be a wet-cooling tower of a power plant.

A fourth embodiment of the present subject matter comprises the third embodiment, further including that the microemulsion comprises at least one oil and at least one surfactant, the at least one surfactant molecules comprising a hydrophobic end and a hydrophilic end.

The fourth embodiment may further include that the at least one oil has a boiling point greater than about 100° C. at 100 kPa, optionally wherein the at least one oil has a carbon-hydrogen atomic fraction of greater than about 70%.

Either or both of the fourth or subsequent embodiments may further include the at least one oil comprises at least one polyalphaolefin.

Any of the fourth or subsequent embodiments may further include that the at least one surfactant comprises at least one of organosulfate salts, sulfonates salts or anhydride amino esters. The at least one surfactant may comprise at least one of sodium dodecyl sulfate or dioctyl sodium sulfosuccinate.

The method of the third, fourth or subsequent embodiments may further include that the cooling source is supplied from an ambient environment.

The method of the third, fourth or subsequent embodiments may further include that the heat supplied to the desorption chamber is directly or indirectly supplied from a waste heat source supplied from a steam generator of the power plant.

It will be understood that the embodiments described herein are merely exemplary, and that one skilled in the art may make variations and modifications without departing from the spirit and scope of the invention. All such variations and modifications are intended to be included within the scope of the invention as described hereinabove. Further, all embodiments disclosed are not necessarily in the alternative, as various embodiments of the invention may be combined to provide the desired result.

What is claimed is:

1. A heat transfer apparatus comprising:
(i) an adsorption/absorption chamber in fluid communication with an exhaust stream from a wet-cooling tower and in heat transfer communication with a cooling source, the adsorption/absorption chamber containing a microemulsion which adsorbs/absorbs water vapor present in the exhaust stream, when cooled, as water droplets sequestered within the microemulsion to form a used microemulsion; and
(ii) a desorption chamber in fluid communication with the adsorption/absorption chamber and the wet-cooling tower, and in heat transfer communication with a heat source capable of desorbing the water droplets out of the used microemulsion as liquid water, without vaporizing the water, to form a regenerated microemulsion.

2. The heat transfer apparatus of claim 1, wherein the wet-cooling tower is a wet-cooling tower of a power plant.

3. The heat transfer apparatus of claim 1, wherein the desorption chamber comprises a separating device capable of: (a) separating the liquid water from the regenerated microemulsion; (b) routing the liquid water to the wet-cooling tower; and (c) routing the regenerated microemulsion to the adsorption/absorption chamber.

4. The heat transfer apparatus of claim 1, wherein the microemulsion comprises at least one oil and at least one surfactant, the at least one surfactant molecules comprising a hydrophobic end and a hydrophilic end.

5. The heat transfer apparatus of claim 4, wherein the at least one oil has a boiling point greater than about 100° C. at 100 kPa, optionally wherein the at least one oil has a carbon-hydrogen atomic fraction of greater than about 70%.

6. The heat transfer apparatus of claim 4, wherein the at least one oil comprises at least one polyalphaolefin.

7. The heat transfer apparatus of claim 4, wherein the at least one surfactant comprises at least one of organosulfate salts, sulfonate salts or anhydride amino esters, optionally wherein the at least one surfactant comprises at least one of sodium dodecyl sulfate or dioctyl sodium sulfosuccinate.

8. The heat transfer apparatus of claim 1, wherein the adsorption/absorption chamber comprises an adsorption/absorption tower in fluid communication with the wet-cooling tower to receive the exhaust stream, wherein the cooling source comprises a source of ambient air adapted to transport the ambient air through the adsorption/absorption tower cocurrently with the exhaust stream, and wherein the adsorption/absorption tower is adapted to transport the microemulsion through the adsorption/absorption tower countercurrently to the exhaust stream and the ambient air.

9. The heat transfer apparatus of claim 1,
(i) wherein the desorption chamber comprises a heat exchanger having a first side and a second side,
(ii) wherein the first side comprises an inlet and an outlet,
(iii) wherein the first side inlet is in fluid communication with the adsorption/absorption chamber to receive the used microemulsion,
(iv) wherein the first side outlet is in fluid communication with the separating device to exhaust the regenerated microemulsion and the liquid to the separating device, and
(v) wherein the second side is in direct or indirect heat transfer communication with a heat source supplied from a steam generator of a power plant.

10. The heat transfer apparatus of claim 1, further comprising a heat exchanger having a first zone and at least one of a second zone or a third zone,
(i) wherein the first zone comprises an inlet and an outlet,
(ii) wherein the second zone comprises an inlet and an outlet,
(iii) wherein the third zone comprises an inlet and an outlet,
(iii) wherein the first zone inlet is in fluid communication with the adsorption/absorption chamber to receive the used microemulsion,
(iv) wherein the first zone outlet is in fluid communication with the desorption chamber to exhaust the used microemulsion to the desorption chamber,
(v) wherein the second zone inlet is in fluid communication with the separation device to receive the regenerated microemulsion,
(vi) wherein the second zone outlet is in fluid communication with the adsorption/absorption chamber to return the regenerated microemulsion to the adsorption/absorption chamber,
(vii) wherein the third zone inlet is in fluid communication with the separation device to receive the liquid water,
(viii) wherein the third zone outlet is in fluid communication with the wet-cooling tower to return the liquid water to the wet-cooling tower,
(ix) wherein at least one of the regenerated microemulsion or the liquid water is cooled via the heat exchanger, and
(x) wherein the used microemulsion is heated via the heat exchanger.

11. A method of condensing water vapor and/or capturing water droplets in an exhaust stream exiting a wet-cooling tower comprising:
(i) transporting the exhaust stream into an adsorption/absorption chamber containing a microemulsion;
(ii) providing the adsorption/absorption chamber with a cooling source to cause the microemulsion to adsorb/absorb the water vapor as water droplets sequestered within the microemulsion, forming a used microemulsion;
(iii) transporting the used microemulsion into a desorption chamber;
(iv) providing the desorption chamber with a heat source to cause the water droplets in the used microemulsion to be released from the used microemulsion as liquid water, forming a regenerated microemulsion;
(v) separating the liquid water from the regenerated microemulsion;
(vi) routing the liquid water to the wet-cooling tower;
(vii) routing the regenerated microemulsion to the adsorption/absorption chamber; and
(viii) optionally cooling at least one of the regenerated microemulsion or the liquid water by placing at least one of the regenerated microemulsion or the liquid water into heat transfer contact with the used microemulsion.

12. The method of claim 11, wherein the wet-cooling tower is a wet-cooling tower of a power plant.

13. The method of claim 11, wherein the microemulsion comprises at least one oil and at least one surfactant, the at least one surfactant molecules comprising a hydrophobic end and a hydrophilic end.

14. The method of claim 13, wherein the at least one oil has a boiling point greater than about 100° C. at 100 kPa, optionally wherein the at least one oil has a carbon-hydrogen atomic fraction of greater than about 70%.

15. The method of claim 13, wherein the at least one oil comprises at least one polyalphaolefin.

16. The method of claim 13, wherein the at least one surfactant comprises at least one of organosulfate salts, sulfonates salts or anhydride amino esters, optionally wherein the at least one surfactant comprises at least one of sodium dodecyl sulfate or dioctyl sodium sulfosuccinate.

17. The method of claim 11, wherein the cooling source is supplied from an ambient environment.

18. The method of claim 11, wherein the heat supplied to the desorption chamber is directly or indirectly supplied from a waste heat source supplied from a steam generator of the power plant.
